(19) United States
(12) Patent Application Publication
(10) Pub. No.: US 2005/0059452 A1
(43) Pub. Date: Mar. 17, 2005

(54) Video poker game with surrender feature

(75) Inventor: Josef Alexander Hartl, Las Vegas, NV (US)

Correspondence Address: BELL, BOYD & LLOYD LLC, P. O. BOX 1135, CHICAGO, IL, 60690-1135, US

(73) Assignee: Shuffle Master, Inc.

(21) Appl. No.: 10/663,403

(22) Filed: Sep. 15, 2003

(51) Int. Cl. A63F 13/00; A63F 9/24

(52) U.S. Cl. 463/13

(57) ABSTRACT

A video gaming system provides a game of video draw poker or a variation thereof in which a player may withdraw exactly 40% or exactly 60% of any wager on any hand (surrendering 60% or 40% of the initial wager, respectively). The game may end upon the surrender, or the odds within the pay table may change with continued play of the game with the residual of the wager. In another variant, the player may withdraw a percentage of the original wager, have the initial pay table altered, and the game is allowed to continue.

### BACKGROUND OF THE INVENTION

1. Field of the Invention

The game of video poker has been one of the most successful game formats in casino gaming. Some of the earliest gaming devices that ultimately led to slot machines and reel-type machines used poker indicia and poker rankings in the play of the games. The advent of the video gaming apparatus has not detracted from the success of poker-based video gaming apparatus. There are many different types of poker games and poker formats that have been used commercially.

2. Background of the Art

A basic format of the play of poker in video games and one of the most successful variations is based on Five-Card Draw Poker. The player plays against a pay table, attempting to achieve ranked hands that win in the game, the less frequently appearing hands paying higher odds on the initial wager. One standard game is Jacks or Better Poker, wherein a player wins at least 1× on any wager when the player's final hand rank is at least a Pair of Jacks. There is usually a fixed pay table in the play of the game, with payout rates varying according to variations in the rules of the game. The player places a wager and is dealt five cards from a virtual deck, face up. The player inspects the cards and decides which cards to retain (hold) or which cards to discard. The identification of these cards is made with user controls, such as a keyboard, buttons, touch screen or other player/user input device. Cards identified or allowed to be discarded are remove from the screen, and replacement cards from the virtual deck are dealt for each of the discards. Usually, no additional wagers are made. The final rank of the player's hand is determined and the hand is compared with a pay table. A typical set of payouts on such a pay table scale would be One Pair, 1:1 odds; Two pair, 2:1 odds, Three-of-a-Kind, 3:1 odds; Straight, 4:1 odds; Flush, 5:1 odds; Full House, 7:1 odds; Four-of-a-kind, 50:1 odds, Straight Flush, 250:1 odds; and Royal Flush 1,000:1 odds.

There are many variants of this game, with Wild Cards, Jokers Wild, Deuces Wild, special bonuses on certain hands (such as Four-of-a-Kind with 2's, 3's or 4's), bonus games or bonus play with high ranking hands, and the like. One unusual format of play in poker-style gaming systems is taught in U.S. Pat. No. 5,823,873 (Moody) wherein multiple hands of poker are wagered on and multiple hands from individual virtual decks are dealt face down, and one hand is turned face up. The player selects cards to be held or discarded from the exposed hand and executes the deal/discard function. The selected cards to be retained in the one exposed hand are inserted into each of the other hands wagered upon. Replacement cards are separately and independently placed into each of the hands wagered upon from the individual virtual decks. Each of the final hands is evaluated against a pay table and each of the wagers on the hands is resolved. This game is marketed under the name “TRIPLE PLAY POKER™” when there are precisely three poker hands played at the same time.

The term surrender has been used in a number of different ways in the gaming art. In Blackjack, it has a uniform meaning of a player withdrawing exactly one-half the initial wager and forfeiting exactly one-half of the initial wager. The dealer collects the player cards, and no further play is performed on that hand by the player. The dealer may continue play if there are other players on the table. In a known video version of blackjack, after a player surrenders, the dealer's hand play ends without cards being disclosed.

The term surrender has a similar meaning in certain video versions and table versions of baccarat. The player may view the initial two-card hand dealt to the player, surrender the hand, and receive one-half of the initial wager back. The other half of the wager goes to the house.

The term surrender has been used with varying meanings in the poker field, both on table games and in video versions of poker. The two general meanings that have been applied in the poker art to “surrender” include folding (an outright forfeiture-type surrender, with all wagers made to that point of time being lost) and some variants approaching a blackjack type surrender.

Bourbour et al., U.S. Pat. No. 6,561,897 describes the game of Texas Hold 'Em and Hold 'Em Challenge poker game variations in which one or more players play against the house, the player(s) place bets and then three face-up hands consisting of two cards each are dealt. Player(s) each choose one of the three hands by placing a wager on the hand and then five communal cards are dealt face-up. In a first embodiment, all five communal cards are dealt face-up at one time, and then the winning hand(s) are determined by comparing the three hands in conjunction with the communal cards using poker rank as the criterion for comparison. Players may use any combination of the two player hold cards and the five communal cards to make a best five-card hand from the seven cards. In another variant, the players may have to use at least one or both of their two player hole cards in combination with three of the five communal cards to make a best five-card hand. Each player betting on the winning hand wins his or her bet if the player holds one of a number of winning hands. The player is paid posted odds on his winning hand. In a second embodiment, three of the five communal cards are turned face-up, after which all players have the option of surrendering one-half of their bet and folding. After the surrender opportunity, the remaining two communal cards are turned face-up and the winning hand determined using poker rank as the criterion for comparison. A third embodiment is identical to the second embodiment, with the exception that winning players are paid a bonus amount depending upon the poker rank of the winning hand. For example, a royal flush pays 50 to 1, a straight flush pays 20 to 1, etc. A novel gaming table layout for use in the live casino versions of the game is also used. A typical payout schedule would be as follows: The withdrawal is in a specific poker-type game and is exactly 50% of any wager.

In blackjack, Walker et al., U.S. Pat. Nos. 6,540,230 and 6,523,829 describe “Surrender” as providing each player with the option of terminating a round of play after the starting hands have been dealt, for use in situations where that player has been dealt a “bad” starting hand that is likely to bust (if an additional card is drawn) or to lose to the dealer's hand (if an additional card is not drawn). If, for example, a player's starting hand consists of a 5 and a 10 and the dealer's up-card is a Jack of diamonds, only an additional card of 6 or below will not “bust” the player, while “standing” with only 15 points is likely to lose to the dealer. In this situation, the player is likely to bust or lose. Surrender is typically practiced by the player taking back one-half of his initial bet and “surrendering” the other one-half of his initial bet to the dealer while terminating the round of play. For example, if a player who made a $10 initial bet surrenders, he takes back $5 of his initial bet, surrenders the other $5 to the dealer, and terminates the round of play. The surrender option has not proven to be popular among Blackjack players. This is standard definition language and descriptions for blackjack surrender.

Hesse et al., U.S. Pat. No. 5,397,128 is described as a hybrid of blackjack and baccarat “similar enough” to Pan 9 (at least in learnability; col. 9, lines 47-50) that uses a player/banker and is designed to give a small advantage to the banker (col. 5, lines 20-25). The player/banker is given the small advantage by adjusting the number of nines in the deck and by the selection of a banker's winning hand of predetermined value, namely: if the banker has a natural nine (no hit was made), this beats anything except another natural nine. Surrender, double and jackpot options are taught. Other rule variations, besides including nines, make this game a departure from Super Pan 9. These are standard surrender rules for blackjack and baccarat and do not relate to poker surrender.

Jacob et al., U.S. Pat. No. 5,395,119 teaches a surrender option in baccarat. Srichayapom, U.S. Pat. No. 5,810,360 teaches the concept of the players playing against each other rather than against a bank. These are standard surrender rules for baccarat.

Sklansky et al., U.S. Pat. No. 6,511,068 describes the following play format in the specification for a particular poker game. The electronic device 1300 may be programmed to limit the number of tokens that can be bet on a single hand. After the player is satisfied with the amount bet, the player pushes the DEAL button 1376, which causes the device 1300 to “deal” face-up the two-card starting hands, which in the illustrated embodiment includes three starting hands HAND #1, HAND #2, and HAND #3. The player pushes the SELECT HAND button 1373 one or more times to select one of the starting hands. A suitable visual indication of the hand selected is preferably provided. For example, the HAND #1 indicia may be illuminated if the player selects that starting hand. After the player is satisfied with the selected starting hand, the player pushes the FLOP button 1374, causing the device 1300 to “deal” all of the communal cards face-up for the multiple flops, such as flop-A 1320, flop-B 1330 and flop-C 1340. In one embodiment of the invention, all of the cards associated with each flop will be revealed. In other embodiments, a predetermined subset of each of the flops is revealed while leaving one or more cards face down. Leaving one or more cards face down provides an opportunity for placing additional bets prior to revealing the entire resulting hand, and/or may afford the participant an opportunity to surrender a portion of his or her bet and fold by depressing the FOLD button 1375.

This is an ambiguous reference to a form of surrender in a particular format of poker. Even though in a video version, it is not five-card draw poker and there is no specific amount of surrender stated.

Baranauskas, U.S. Pat. No. 6,446,971 describes a card game that may be played with the higher ranking cards or portion of a deck, said portion comprising the card ranks of Nine through Ace of a typical fifty-two card Poker deck or with a typical forty-eight card Pinochle playing card deck or with a conglomeration of multiple said decks, said cards not having a standard rank and said game does not involve the generally well recognized and accepted set of rules, procedures and hand resolving outcomes of typical Pinochle or Poker game play. The card ranks of Two through Eight are not used. The game method comprises each player placing an initial wager to participate in the game. Cards are dealt by a dealer, one card is dealt to each player and two cards are dealt to the dealer or house. Next, after the players view their card said players are queried by the dealer that they can continue with their one card hand or that they can surrender their one card hand. Players that choose to surrender said hand can by forfeiting part of their initial wager. Those players that chose to continue their hand now have the option of being allowed to place an additional wager, for example a double down wager, next to their initial wager. Next, players can draw up to two additional cards without placing an additional wager. Players that choose not to draw said additional cards must pay a wager amount for each of the two said cards not drawn. After all players are content with, and/or finished drawing cards to their hands the dealer draws the third and final card for the houses hand. Dealer reveals the houses cards and totals the houses hand cards value using a method unique to the present invention comprising of converting all cards standard rank with a different whole or fractional numerical rank value. After totaling the houses hand value using the above-mentioned method, the dealer verbally announces said value to the players. The dealer examines each of the player's cards and resolves each player's bet. Players are not playing against the dealer, house or against each other. An example of surrendering one half the wager is given. This is an ambiguous reference to a form of surrender in a particular format of poker. It is not five-card draw poker and there is no specific amount stated, other than the 50% limit.

Suttle et al., U.S. Pat. No. 4,836,553 teaches Caribbean Stud® poker and Piccoli, U.S. Pat. No. 6,435,506 teaches an improvement therein wherein an initial wager is forfeited and that play is termed a surrender, even though the entire wager is lost. This is a forfeiture-type surrender.

Similarly in Reed, U.S. Pat. No. 6,406,020, Ante bets are bets made before a player is dealt a hand. In a Hi-Lo game, that is a game involving both high and low hands, a player has the option of placing a Hi ante bet, a Lo ante bet, or both, to be eligible to participate in the game. Play bets are bets made after viewing the hand dealt. In a Hi-Lo game, a player has the further option of either placing a Hi play bet, a Lo play bet, or both betting that the player's hand will beat the banker's hand, or surrendering the Hi and/or Lo ante bet. A method of playing the card game is defined wherein a player surrenders the HI ANTE bet or LO ANTE bet or both, a predetermined portion of the surrendered bet is placed in a JACKPOT and the remaining portion is paid to the banker. The entire wager is surrendered, although a portion may go into a pot or jackpot credit.

Andrews, U.S. Pat. No. 6,311,979 describes that in some “player-versus-dealer” five-card stud poker table games, the dealer may add face-up cards in sequence to his or her partial hand. The player makes “additional” wagers upon each addition of a card to the dealer's hand. Further, where the dealer's hand (as originally dealt) comprises five cards, the dealer may turn one or more cards face-up in sequence with players making “additional” wagering upon each dealer card turn-up. In either of the foregoing (or other) variations of “player-versus-dealer” five-card stud poker games, the individual player may surrender his or her hand (with any and all wagers) after any wagering round. In such games each player having a higher value hand with respect to the dealer's hand wins the amount of his or her wagers from the dealer. This is a fold of the hand with all wagers lost in a forfeiture-type surrender.

Breeding, U.S. Pat. No. 6,273,424 describes a form of LET IT RIDE® poker in which portions of original bets (⅓ at a time) may be withdrawn from play while the hand remains in play against a play table. The bets not withdrawn remain at risk and are not taken by the house. In the foregoing (or other) variations of “player-versus-dealer” five-card stud poker games, the individual player may surrender his or her hand (with any and all wagers) after any wagering round. In such games each player having a higher value hand with respect to the dealer's hand wins the amount of his or her wagers from the dealer. This is another variant usage of the term “surrender” and has the unusual attribute of the game remaining active for the player and the remaining wager(s) after surrender.

Chamberlain, U.S. Pat. No. 6,270,079 describes a method of playing a card game. A standard deck of playing cards is used wherein a particular card having a particular value is designated as a dual purpose card that functions as a wild card when face down and a killer card when face up. Each player placing a first predetermined wager and the dealer deals a predetermined number of cards to himself and to each player. At least one of the cards dealt to each player being face down and the card dealt to the dealer being face down. Each player decides whether to stay with the first predetermined wager or place a second predetermined bet that is larger than the first predetermined bet. The dealer deals an additional card to himself and to each player wherein the additional card to each player is face up and the additional cards dealt to the dealer are face down. Next, it is determined if any of the players' face up cards is a killer card. Any player with a killer card must surrender his or her bets and withdraw from play. These steps are repeated. It is then determined if the dealer's hand has a value that is greater than or equal to the value of a predetermined qualifying poker hand. If the dealer does not have a hand that has a value that is greater than or equal to the value of the predetermined qualifying poker hand, then winnings are provided to each player based on each player's first predetermined wager. This is another variant of the use of the term surrender in a poker game.

Brunelle, U.S. Pat. No. 6,189,888 describes a unique game in which a surrender of ½ the wager may be made at a specified time. A wagering card game is played with a standard fifty-two card poker deck and a count limit card that is permanently assigned as the third card of the dealer's hand. Each player makes a bet, divides the bet in half and places each half in two separate betting areas on a playing surface. Two cards are dealt face down to each player and to the dealer. The players inspect their cards and keep or trade one or both cards. If a player trades, he surrenders one-half his total wager. Replacement cards are dealt face down and the dealer collects the surrendered bets. After evaluating his hand, each player then places his cards face up in progressive order into card docks provided on the playing surface. A third card is then dealt face down to each player, but not to the dealer. The dealer's third card is a count limit card or the representation of a count limit card having a predetermined count value (for example 5) that is imprinted on the count limit card or on the playing surface, and is displayed at all times. The dealer turns over his cards, combines his dealt cards with his count limit card and states his total. He then turns over each player's third card one at a time, compares each player's hand with the dealer's hand, determines whether the player is a winner or not and pays or collects on each hand. This is a count-type game rather than a poker game, and the surrender value is one-half of the original wager.

Vancura, U.S. Pat. No. 6,179,291 describes a game, including card games with collective values in dealer and player hands competing against each other in a manner similar to blackjack. The specification indicates that in one embodiment, players may make an additional wager, pay a fee, or surrender a portion of their original wager, to substitute a newly dealt event for an undesirable event. There are no other specifics mentioned with respect to the surrender play.

Mostashari, U.S. Pat. No. 6,113,103 describes a variation of Pai Gow Poker known as Dragon Poker, in which a player posts a wager and is dealt a first four of seven cards face down. A bank is dealt a first a first four of seven cards, three of which are dealt face up. The player is then given an option of surrendering and receiving a return of a portion of the wager. With the surrender, the player's participation in the game is at an end. The player who does not surrender is a surviving player who may be given an option of increasing the wager. The surviving player and the bank are each dealt three additional cards to enable formation of a player backhand and a player front hand and formation of a bank back hand and a bank front hand. After the hands are formed, the wager is resolved.

Morosky, U.S. Pat. No. 6,065,753 describes a baccarat variant in which the preferred embodiment provides three different hands of three cards each. Each hand is dealt into the portion of the dealing area that corresponds to that particular hand. After the players place their wagers on a character and/or on a tie, the first card is dealt face up to each hand and the dealer announces the point totals as shown in FIG. 1 (7). Each player is now given a first opportunity to alter his wager (8) as follows: he can “double down” or increase his wager in an amount up to the original wagered amount (9), he can keep his original wager unchanged (10), or he can surrender (11). If the player surrenders, he returns one half or some other predetermined portion of his wager to the house and withdraws from the hand. Once all players have been given the opportunity to alter their wagers each hand is dealt a second card and the dealer announces the point totals (12). Each player is then given a second opportunity to alter his wager (13): he can either surrender (14) by forfeiting one half or some other predetermined portion of the wager and withdrawing from the hand, or he can keep his original wager unchanged and play out the hand (15). This is a baccarat game, even though the surrender portion is not specifically one-half, that amount is the only amount shown in the specification. Hansen et al., U.S. Pat. No. 5,951,052 describes an embodiment of novel poker games which require players to place wagers in predetermined amounts, subsequent to placing an initial wager and before receiving cards necessary to complete the player's hand. According to the various embodiment of the present invention, if a player decides not to make a subsequent wager, the player automatically folds his/her hand and forfeits his/her opportunity to receive a winning payout for that hand and loses the ante and prior wagers. The players must therefore make decisions prior to receiving all of their cards. Optionally, rather than folding and losing all wagers for the game, a player not wishing to continue in the game may “surrender,” and forfeit only half of his/her wagers. Whether to allow a player to surrender is determined prior to the game. Whether all or only a portion of the ante is forfeited is also determined prior to the game. This is a particular game format, and the surrender value is exactly one-half.

Mastashari, U.S. Pat. No. 5,944,315 describes a game where a player makes a wager. After three cards are dealt face down to the player and two cards are dealt face up to a dealer, the player chooses to continue the risk of the wager, surrender and forfeit half of the wager, double the wager or triple the wager when the two face up cards are a pair. When the player does not choose to surrender, the player is dealt two additional cards. The player designates one of his cards as a Joker whereby the player has a Poker hand comprised of four cards and a Joker. The dealer is dealt three additional cards. The dealer designates one of his cards as a Joker whereby the dealer has a Poker hand comprised of four cards and a Joker. A payout is made to the player when the player's hand has a rank that is at least as high as the rank of the dealer's hand. The player may participate in a jackpot by contributing money to a jackpot pool prior to cards being dealt. A payout from the pool is based upon the rank of the player's hand. This is a particular game format, and the surrender value is exactly one-half.

Delaney et al., U.S. Pat. No. 5,911,419 describes a poker game where players are permitted to draw up to three additional cards after the deal, placing their discards in their respective discard fields. A player may also surrender all five of the dealt cards, and forfeit one-half of the player's bet. In any event, beginning once again with the “buttoned player”, the dealer removes the discards and replaces them with an equal number of new cards. The dealer will continue on a player-by-player basis, providing replacement cards for any cards discarded, until all of the players have received up to their three new cards, have decided to forfeit or have not accepted any new cards and have decided to “stand pat”. This is a particular game format, and the surrender value is exactly one-half.

Jacob et al., U.S. Pat. No. 5,395,119 sets forth wagering methods for Baccarat. The patent provides a variation to Baccarat wherein different types of “surrender” are provided wherein a player may surrender a portion of the bet depending on the value of the first two cards of the player and the banker hands. A separate surrender region is placed on the gaming table. This variant provides additional types of wagers that may be placed during the play of the game to increase the interest on the part of the players and to increase the profitability of the game for the casino. This is a baccarat-only teaching of surrender.

Wood et al., U.S. Pat. No. 5,511,781 states that a game is connected via a bi-directional serial communication link to a central processing unit acting as an expected value computing module that will calculate the stop play or surrender award for the video poker game described according to a formula (1). This is only a general functional description of video apparatus with a surrender feature.

Sklansky et al., U.S. Pat. No. 5,382,025 describes a poker game variation in which one or more players play against the house, the player(s) place bets and then three face-up hands consisting of two cards each are dealt. Player(s) each choose one of the three hands and then five communal cards are dealt face-up. In a first embodiment, all five communal cards are dealt face-up at one time, and then the winning hand(s) is determined by comparing the three hands in conjunction with the communal cards using poker rank as the criterion for comparison. Each player betting on the winning hand wins his or her bet. In a second embodiment, three of the five communal cards are turned face-up, after which all players have the option of surrendering one-half of their bet and folding. After the surrender opportunity, the remaining two communal cards are turned face-up and the winning hand determined using poker rank as the criterion for comparison. A third embodiment is identical to the second embodiment, with the exception that winning players are paid a bonus amount depending upon the poker rank of the winning hand. Live casino and video poker versions of each of the three embodiments of the game are disclosed. A novel gaming table layout for use in the live casino versions of the game is also disclosed. This is a particular game format, and the surrender value is exactly one-half.

It is desirable to offer other features to game players that can contribute to both their enjoyment and a sense of control over the play of the game and to provide additional opportunities for players to cut their losses.

### SUMMARY OF THE INVENTION

A video gaming system provides a game of video draw poker or a variation thereof in which a player may withdraw exactly 40% or exactly 60% of any wager on any hand (surrendering 60% or 40% of the initial wager, respectively). The game may end upon the surrender, or the odds within the pay table may change. According to one version of the game, the player cannot surrender when his hand is a winning hand to prevent a layer from making a playing error.

### BRIEF DESCRIPTION OF THE FIGURES

FIG. 1 shows a video gaming apparatus useful in the practice of the invention.

FIG. 2 shows a touch-screen panel with user inputs that can perform the play of the present invention.

### DETAILED DESCRIPTION OF THE INVENTION

The play of the present game is not unique to play in a video gaming format, but may also be played in a casino table game format. There are distinct advantages of speed in the play of the video game format that lends itself to favored play in that format.

The game is particularly advantageously played against a pay table and not against a dealer's hand or against other players' hands. In the play of Video Draw Poker or any other variant of that game, a player is ordinarily dealt five cards face-up. The player may hold (retain) zero to five cards, discard the other cards, and have the discarded cards replaced, usually by pressing a “Draw” or “Deal” button. The player may place a minimum to maximum wager in the play of the game, may play a singe hand or may play multiple hands.

In the main variant of the present draw poker variation, the player places a wager, reviews the cards in a single dealt player hand, and determines whether to discard none, one, two, three, four or five cards from the hand to receive replacement cards. He may Surrender according to the rules of this game before discarding and drawing replacement cards. The surrender is very specific in one video gaming format, where exactly 40% or exactly 60% of the initial wager must be forfeited. The preferred format is to have the player forfeit exactly 60% of the initial wager and have the Surrender available only when the player is playing “Max Bet”—the maximum number of coins that can be played simultaneously in a game. The hand is then withdrawn from the screen, 40% of the credits are returned to the player (in payout mode or credit mode), and the next game is made available. It is an option to have the next sequence of replacement cards displayed to the player after the Surrender has been executed. It is also possible to have one forfeiture rate without viewing the complete set of player cards (e.g., on seeing a flop or community cards or seeing a player's initial cards in a five-card poker hand) or even the prospective cards and a second forfeiture rate with an opportunity to see the next sequence of cards or even have the replacement cards shown, the player playing a ‘free’ game, with no chance of winning, but having already forfeited a 40% or 60% portion of the initial wager.

The play of the game may require that the player make a wager in credit units that are exactly multiples of five credit units to allow for a Surrender option, as that is a typical maximum wager multiple (e.g., 5 units maximum or 10 units maximum). This will stimulate higher wagers on the game. The game may require higher wagers or the highest wager to allow the option of Surrender according to the game.

The play of the game may also allow the player to surrender any portion of the initial wager (including 10%, 20%, 30%, 40%, 50%, 60%, 70%, 80%, or 90% and even intermediate amounts not divisible by 5%) and have the pay table rates change based on the surrender or the amount of the surrender. In this mode, the following pay tables might be available at different stages of the play of the game.

### WITHOUT SURRENDER

| HAND RANK | PAYOUT ODDS |
|---|---|
| ONE PAIR | 1:1 |
| TWO PAIR | 2:1 |
| THREE-OF-A-KIND | 3:1 |
| STRAIGHT | 4:1 |
| FLUSH | 5:1 |
| FULL HOUSE | 7:1 |
| FOUR-OF-A-KIND | 20:1 |
| STRAIGHT FLUSH | 100:1 |
| ROYAL FLUSH | 1000:1 |

### WITH 40/SURRENDER

| HAND RANK | PAYOUT ODDS |
|---|---|
| ONE PAIR | 0:1 |
| TWO PAIR | 2:1 |
| THREE-OF-A-KIND | 2:1 |
| STRAIGHT | 3:1 |
| FLUSH | 5:1 |
| FULL HOUSE | 5:1 |
| FOUR-OF-A-KIND | 10:1 |
| STRAIGHT FLUSH | 50:1 |
| ROYAL FLUSH | 500:1 |

### WITH 60% SURRENDER

| HAND RANK | PAYOUT ODDS |
|---|---|
| ONE PAIR | 1:1 |
| TWO PAIR | 1:1 |
| THREE-OF-A-KIND | 2:1 |
| STRAIGHT | 3:1 |
| FLUSH | 4:1 |
| FULL HOUSE | 5:1 |
| FOUR-OF-A-KIND | 10:1 |
| STRAIGHT FLUSH | 50:1 |
| ROYAL FLUSH | 250:1 |

### WITH 80/SURRENDER

| HAND RANK | PAYOUT ODDS |
|---|---|
| ONE PAIR | 0:1 |
| TWO PAIR | 1:1 |
| THREE-OF-A-KIND | 2:1 |
| STRAIGHT | 3:1 |
| FLUSH | 3:1 |
| FULL HOUSE | 4:1 |
| FOUR-OF-A-KIND | 8:1 |
| STRAIGHT FLUSH | 25:1 |
| ROYAL FLUSH | 100:1 |

As can be seen, the payout odds can be varied to influence the amount of the wager, the amount of the Surrender, and the decision-making capacity of the player. The odds may be adjusted as the house sees fit to attempt to influence wagering patterns on the game. Further appreciation of the invention will be gained by reference to the Figures.

In one form of the invention, players may only surrender when the initial hand of cards (before holding/discarding) is a losing hand. For example, when the hand has a rank of less than a pair, the player may surrender, but when the player hand is greater than a pair of jacks, the machine programming will not be allowed to surrender. This feature would prevent a player from losing part of his wager when he would otherwise win on the entire wager.

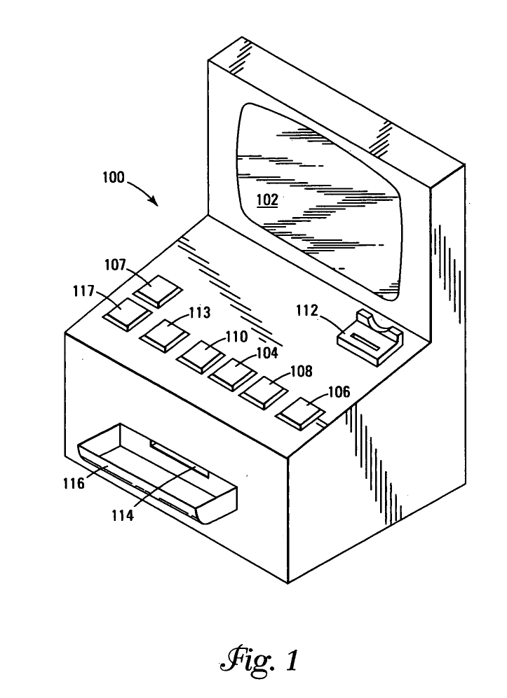

FIG. 1 shows a standard video wagering game apparatus 100. A video screen 102 is shown. The apparatus has a series of, for example, seven buttons 104, 106, 107, 108, 110, 113, and 117. These may have various functions, including but not limited to card control buttons (e.g., 117, 113, 110, 104 and 108). Wager amount or Deal and Draw button 106 and Surrender button 107. Other functions (not shown) controlled by buttons, key pads, or touch screen controls may be, by way of non-limiting examples, Cash Out buttons, Change/Alert buttons, game selection buttons, and the like. A typical currency or coin acceptor 112 is shown, along with a standard coin return slot 114 and coin collection tray 116.

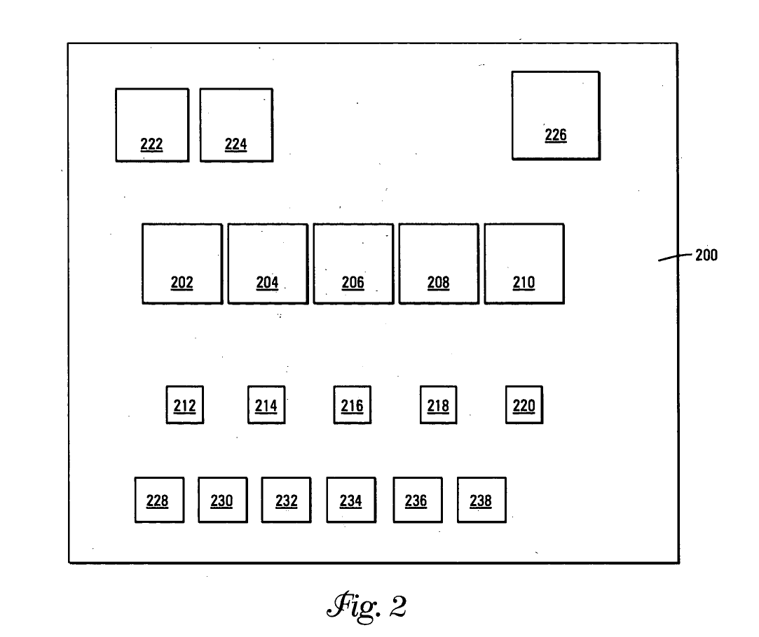

FIG. 2 shows a video screen 200 that can be used with touch functions to play the game of the invention. Frames 202, 204, 206, 208 and 210 can show the cards of the game. User buttons (virtual touch screen buttons) 212, 214, 216, 218 and 220 respectively operate on the frames above them. Bet indicator 222 and credit indicator 224 are shown. A pay table disclosure frame 226 is provided. The image on frame 226 may vary as the amount of the wager is surrendered if continued play is then allowed. Buttons 228, 230, 232, 234, 236 and 238 may control the amount wagered, the number of games to be played (in a multigame display), the execution of the Surrender option, the amount of the initial wager to be surrendered, Cash/Credit payout, Change/Alert signal, and the like. In one example of the invention, a visual indication of the availability of the surrender option is provided in the form of an illuminated button. When the player has a winning outcome, the light goes out and surrender is not available.

Although specific examples of some features have been identified and exemplified, one skilled in the art would appreciate the alternatives and equivalents that could be practiced within the scope of the present description and teachings.

The variation on this game is a draw poker video game with a surrender feature that allows the player to withdraw a portion of the initial wager before there is a final resolution of the game, forfeiting another portion of the wager. When a maximum video wager is placed (with a multiple of five units wagered), a player may view the initial cards and elect to surrender the hand and withdrawn 2/5 units wagered or 3/5 units wagered. In some games, 5 or 10 credits is the maximum wager limit, so the withdrawal for surrender would be 2 or 4 units and 3 and 6 units, respectively, and the rules of the surrender can be dictated to be allowed only with a maximum wager. If the player chooses this surrender object, no cards are held by the player, and no further cards are dealt until the next hand.

As another suggestion to this game, an option might be that a player surrenders a portion of the initial wager (for example, it can be 40%, 60% or 50%), remain in the game, but have the pay tables decrease in value, say by one half. This number will work well with the 60% reduction as the wager will be 40% of the original, which will always be a whole number, while with 50%, some half numbers (e.g., 1.25/2, or 0.25/2) might occur. There would be a significant house benefit because, even if the player wins, the house has recouped a significant amount and the payout is at a lower rate. The house wins on both events.

1. A method of playing a video wagering game of draw poker against a pay table comprising
a player placing a maximum wager on the game;
the player viewing an initial hand;
the player electing to continue ordinary play of the game or surrendering by forfeiting 60% or 40% of the maximum wager and receiving credit for 40% or 60%, respectively of the maximum wager; and
the game ending for the player.

2. The method of claim 1 wherein a possible player's hand cannot be revealed in ending the game for the player.

3. The method of claim 1 wherein a possible player's hand can be revealed to the player.

4. The method of claim 1 wherein the game is five-card draw poker.

5. The method of claim 1 wherein the game is a wild card variant of five-card draw poker.

6. A method of playing a video wagering game of draw poker comprising
a player placing a maximum wager on the game against a first pay table;
the player viewing an initial hand;
the player electing to continue ordinary play of the game or surrendering by forfeiting a predetermined portion of the maximum wager and receiving credit for a remaining portion of the maximum wager;
if the player elects surrendering, the game is continued against a second pay table with payout rates on at least one hand being lower than the payout rate for a same hand as in the first pay table; and
continuing play of the game.

7. The method of claim 6 wherein surrendering may be performed only when a maximum wager has been made in the wagering game.

8. A video poker wagering game machine comprising:
a visual display;
a plurality of player controls including a surrender player control;
a processor and memory, the processor programmed to execute and display a draw video poker game;
and wherein the processor is further programmed to prohibit surrender when an initial displayed hand is one of a plurality of winning outcomes.

9. The device of claim 8, wherein the processor is further programmed to permit execution of a bet surrender when a maximum wager is placed.

10. The device of claim 8, wherein surrender is defined as one of either 40$ or 60% of the initial wagered amount.

11. The device of claim 8, wherein the plurality of winning outcomes are five card poker outcomes.

12. A method of playing a wagering game, comprising:
a player placing a wager to participate in a video poker game;
displaying an initial hand of cards on a video game machine display;
providing an opportunity for the player to surrender a portion of the wager unless the initial hand is a predetermined winning hand;
providing an opportunity to replace cards; and resolving the hand.

13. The method of claim 12 wherein surrender is permitted when the player has placed a maximum bet.

14. The method of claim 12, wherein the surrender is either 40% or 60% of an amount wagered.

15. The method of claim 13, wherein the surrender is either 40% or 60% of an amount wagered.

16. A method of playing a video wagering game of draw poker against a pay table comprising
a player placing a wager in whole credit units on the game;
the player viewing an initial hand;
the player electing to continue ordinary play of the game or surrendering by forfeiting an amount closest in whole credit units to 60% or 40% of the wager and receiving an amount closest in whole credit units credit for 40% or 60%, respectively of the maximum wager; and
the game ending for the player.

17. A method of playing a video wagering game of draw poker comprising
a player placing a wager on the game against a first pay table;
the player viewing an initial hand;
the player electing to continue ordinary play of the game or surrendering by forfeiting a predetermined portion of the wager and receiving credit for a remaining portion of the maximum wager;
if the player elects surrendering, the game is continued against a second pay table with payout rates on at least one hand being lower than the payout rate for a same hand as in the first pay table; and
continuing play of the game.
